(19) United States
(12) Patent Application Publication
(10) Pub. No.: US 2015/0336595 A1
(43) Pub. Date: Nov. 26, 2015

(54) Cart for storage and transport of warning lines

(71) Applicant: BlueWater Manufacturing LLC, Chaska, MN (US)

(72) Inventor: Anthony J. Mertes, Chanhassen, MN (US)

(73) Assignee: BlueWater Manufacturing LLC, Chaska, MN (US)

(21) Appl. No.: 14/285,132

(22) Filed: May 22, 2014

(51) Int. Cl. B62B 1/26; E04G 21/32

(52) U.S. Cl. CPC B62B 1/262; E04G 21/32

(57) ABSTRACT

Wheeled cart for holding components of temporary visible warning assemblies and method of loading. The cart comprises a holding support having adjacent spaces positioned substantially along its length and a holding base having upwardly extending prongs positioned substantially across its length. Warning stands are stored in the cart by connecting a lower end of a stand with a prong and placing the upper end of the stand in the space of the holding support. Surface engaging supports for retaining the cart in an upright position extend from each side wall of the cart frame and are positioned directly below a length of the holding base. A rotatable cover is moveable from an open position for loading stands to a closed position wherein the upper ends of the stands in the cart are retrained from forward or upward movement by the cover.

### FIELD OF THE INVENTION

This disclosure relates to wheeled carts, and in particular it relates to wheeled carts for transporting components of a temporary visible warning system.

### BACKGROUND

Warning lines are visual warning systems for indicating the presence of a hazardous or unsafe area or workspace. Most often, warning lines are found on roof top work surfaces, near a roof top edge, around open areas and in construction zones.

A warning line is generally a length of brightly colored plastic ribbon or tape, sometimes having hanging flags. A plurality of upright stands are placed around a hazardous area to form a perimeter and the warning line is strung from stand to stand. Once the stands are positioned to denote a hazardous or unsafe area, the flag ribbon strung from stand to stand serves as the visual warning that a hazardous condition is present in the perimeter of the warning lines.

The stands are generally constructed of steel or aluminum and must have a weight substantial enough for the stand to remain upright and positioned proximate a hazardous area. Moreover, the stands generally are of a height sufficient such that when the warning line is strung between stands, the warning line would catch the eye of a worker at a distance.

A plurality of stands are generally required to completely surround or denote a hazardous or unsafe area with the warning line itself. As the stands and warning lines are generally temporarily used to denote the hazards of an unsafe area, the stands and line must be transported to and from the hazardous area and stored between uses. It is time consuming and labor intensive for workers to manually carry the stands and the warning line to and from the hazardous or unsafe area. Flat beds and other types of carts are used, but present problems related to storage and efficient transport of all the stands is needed. Moreover, the warning line itself can be tangled in the stands. It can be cumbersome and difficult for workers to transport and alternatively store the plurality of stands and an appropriate length of warning line.

### SUMMARY OF THE INVENTION

The present disclosure relates to a wheeled cart for holding the components of a temporary visible warning assembly. The wheeled cart comprises a frame, wherein the frame comprises a first and second side wall; a holding support and a holding base. The holding support comprises a plurality of spaces, the spaces being adjacent and positioned substantially along a length of the holding support; and wherein each space is open to the extent it is bounded by a rear face, a first side face and a second opposing side face. The holding base comprises a plurality of upwardly extending prongs, the prongs being positioned substantially across a length of the holding base. The cart further comprises a first and second surface engaging support, the first support extending from the first side wall of the frame and directly below a length of the holding base proximate the first side wall and the second surface engaging support extending from the second side wall of the frame and directly below a length of the holding base proximate the second side wall. The cart also comprises a pair of wheels and a rotatable cover, moveable from an open position to a closed position.

The present disclosure is also directed to a method of loading a wheeled cart for transporting components of a temporary visible warning assembly. The method comprises placing a plurality of stands in a wheeled cart. Each stand is similarly loaded into the cart and the method comprises placing a first stand having a hollow lower end over a first prong of a holding base and inserting the first prong into the hollow lower end of the stand by setting the stand down on the holding base. The method further comprises placing an upper end of the first stand in a corresponding gap on an upper retaining support, the support positioned parallel to and above the holding base wherein the support is positioned to the rear of the base such that the support and base holding the stand allow the first stand to rest at a rearward incline and placing the remaining stands in the wheeled cart. The method further comprises closing a cover rotatably attached to the upper retaining support, the cover substantially co-extending with the length of the upper retaining support, by moving the cover from a loading position to the closed position over the upper ends of the plurality of stands.

DESCRIPTION OF THE DRAWINGS

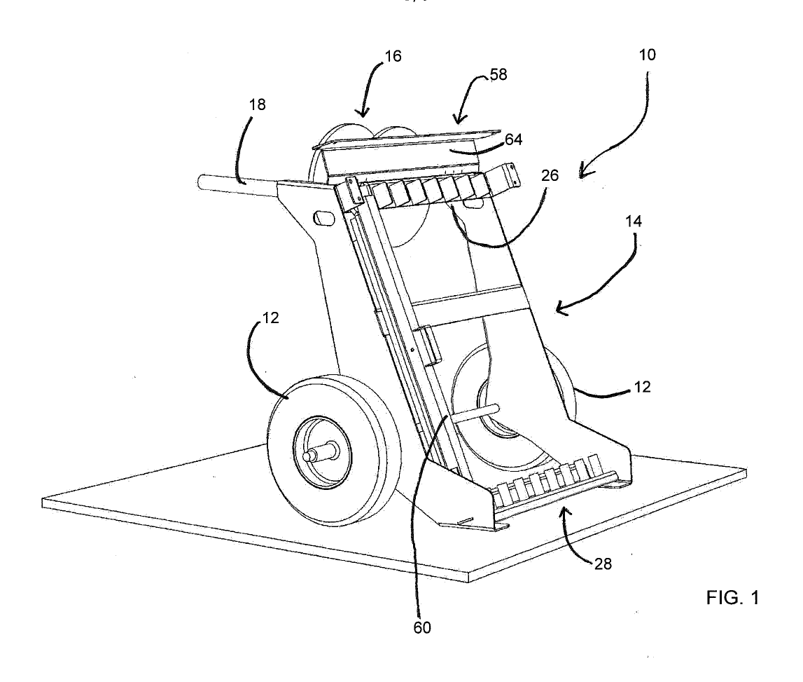

FIG. 1 is a side perspective view of a cart of the present invention.

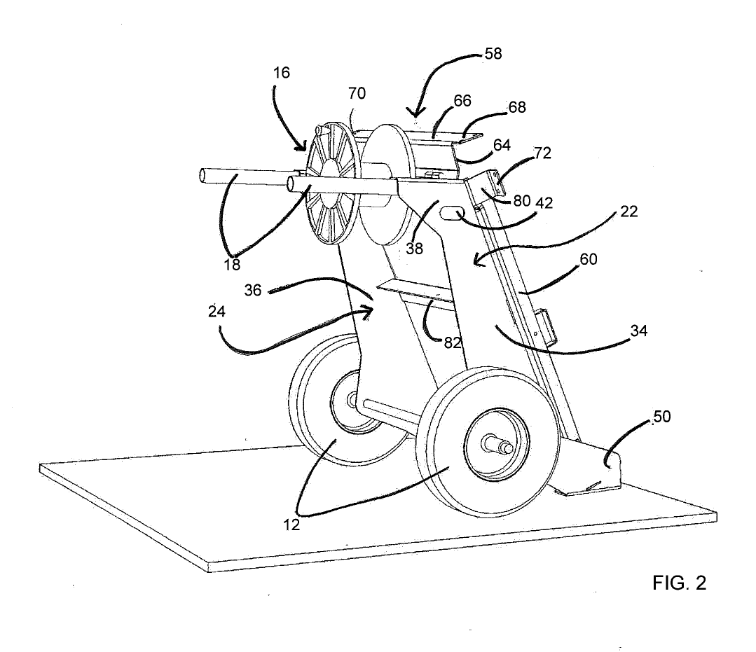

FIG. 2 is back perspective view of the cart of the present invention.

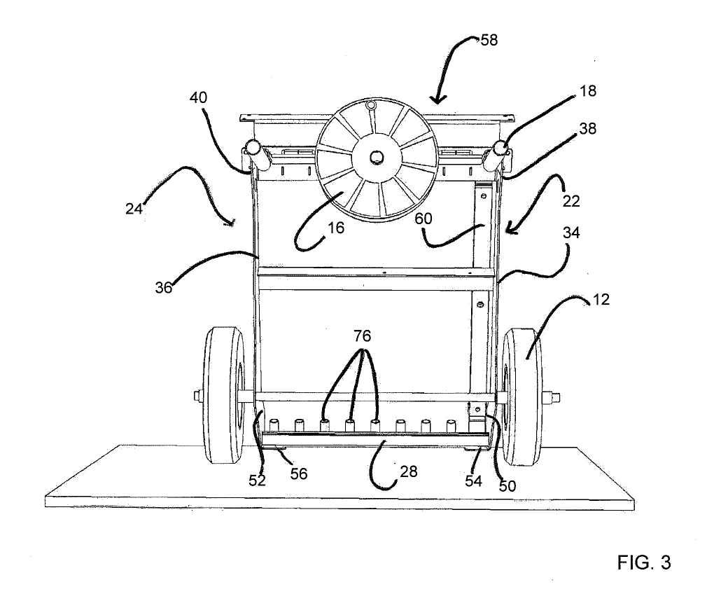

FIG. 3 is a back view of the cart of the present invention.

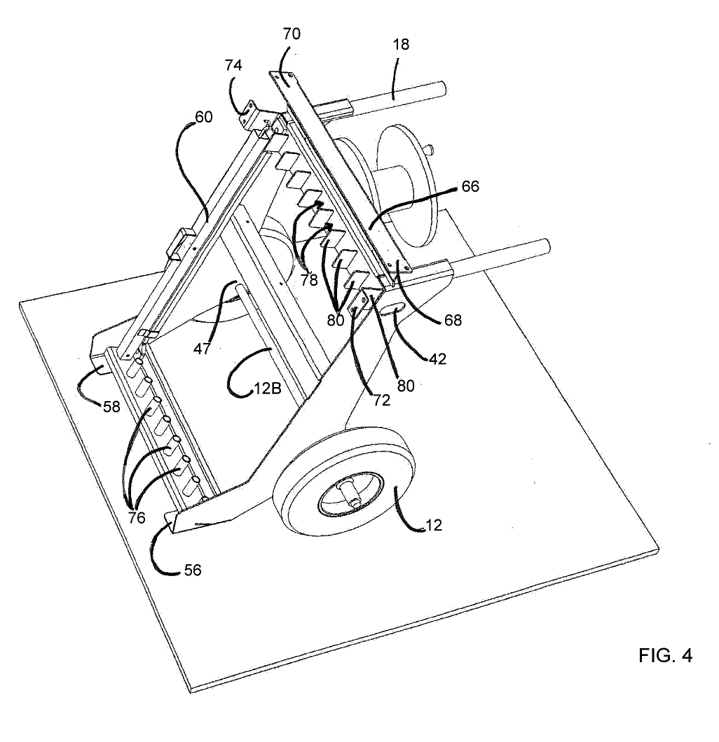

FIG. 4 is a top perspective view of the cart of the present invention.

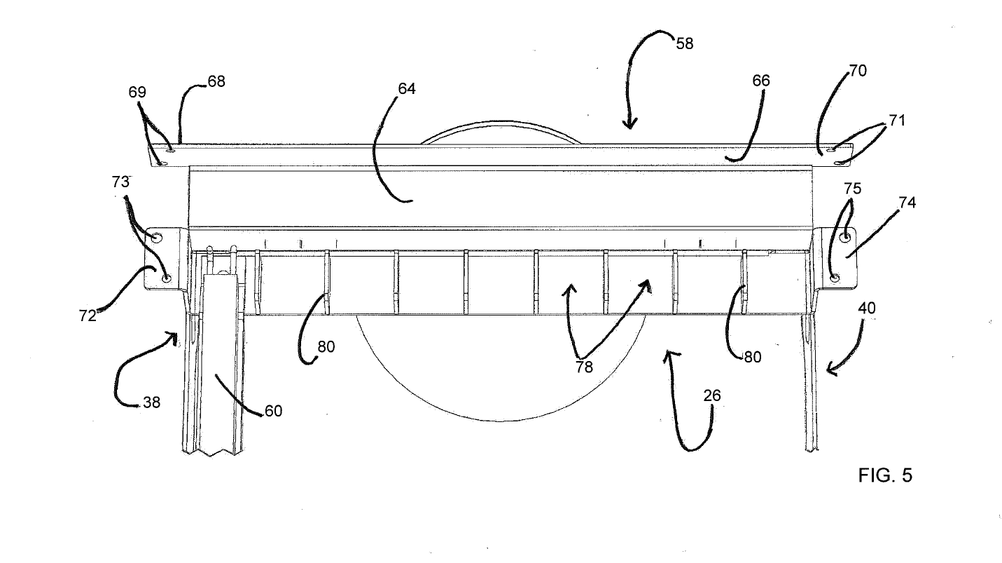

FIG. 5 is a front view of the top of the cart of the present invention.

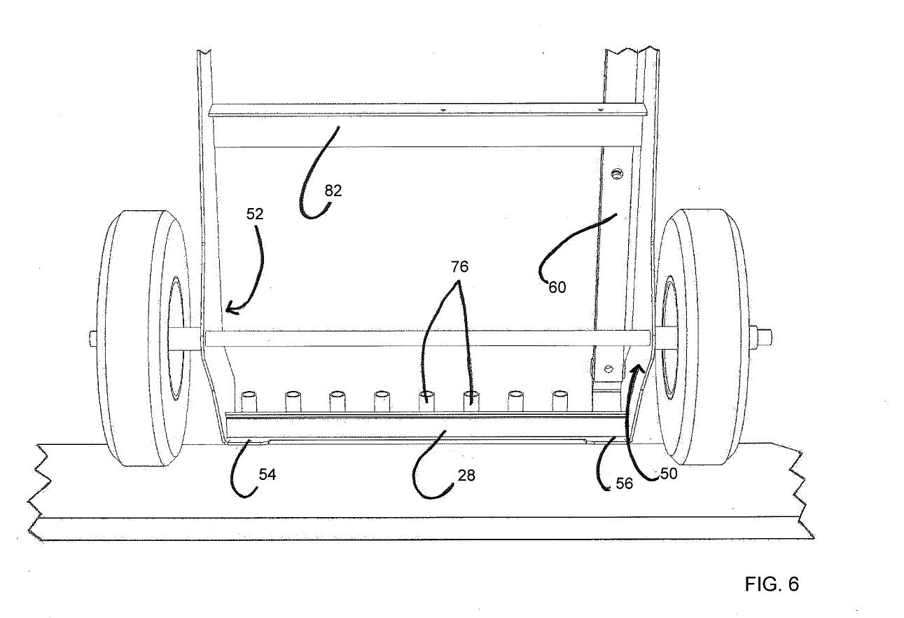

FIG. 6 is a back view of the base of the cart of the present invention.

### DETAILED DESCRIPTION OF THE INVENTION

The cart of the present invention is a wheeled cart for transportation of warning stands and a warning line. The wheeled cart can also be used for storing both the stands and the line when not in use. The cart of the present invention, as illustrated generally at 10 in FIG. 1 is a wheeled cart. The cart 10 has a pair of wheels 12, a frame 14, a rotatable spool 16 for holding warning line, rearwardly extending handles 18 and a storing mechanism 20 for holding at least one warning stand in the cart for transportation or storage. The storing mechanism 20 is further adapted with a cover 58 which can be closed to further secure retained stands 60 in the cart 10.

As illustrated in FIGS. 1-4, the frame 14 has two opposing vertical side walls 22 and 24, which comprise the two parallel sides of the frame 14 and two opposing horizontal supports 26 and 28 which are connected to the side walls to form the frame 14. The horizontal supports are an upper support, also referred to throughout this disclosure as an upper holding support 26 for holding the top portion of at least one stand; and a lower support, also referred to as a holding base 28 for retaining the lower portion of at least one stand. The upper holding support 26 and holding base 28 together form the storing mechanism 20, as will be described in more detail further below.

The upper holding support 26 and holding base 28 are secured to the frame 14 are parallel to one another, and are substantially horizontal with the ground or other surface when the cart is generally in an upright position. The upper support 26 and holding base 28 are secured to and form the frame 14 by a welded or other suitable connection with each of the side walls 22 and 24. As illustrated in the figures, the upper support is secured proximate the top, or upright end, of each side length 22 and 24. The holding base 28 is secured proximate the bottom, or ground/surface engaging ends of the side length 22 and 24. When connected, the upper support 26 is positioned higher than the holding base 28 and at least partially behind the lower holder 26. When a stand 60 is placed in the cart, the stand rests in the cart as the base of the stand is retained by the holding base 28 and the stand 60 is upright and inclined in a rearward direction. Thus, an upper portion of the stand rests on the upper holding support 26.

The side walls 22 and 24 are substantially flat, smooth lengths or sheets of steel, aluminum or another like material having strength and durability, while remaining relatively lightweight for mobility. The side walls 22 and 24 are oriented such that a flat inner facing surface 30 and 32 of each wall 22 and 24 faces inwardly toward the inner surface of the opposing side wall. The side walls 22 and 24 also have a segment 34 and 36 connecting top and bottom ends of the walls. The width gradually increases downwardly along the segments 34 and 36. The shape of the segments 34 and 36 allows the side walls of the frame 14 to remain parallel to one another, while also extending in a forward direction as the width increases. Thus, the walls have a shape wherein the top of the wall is substantially to the left of the bottom of the wall, when the wall is viewed from the left side. In an upright position, the frame 14 has vertical and parallel side walls, and horizontal and parallel supports such that stands 60 can be retained in the cart 10 by the incline provide by the cart 10 construction.

Each side wall 22 and 24 is similarly constructed and adapted with a top end length 38 and 40 that is compatible for secured attachment of a handle 18. The handles 18 extend rearwardly for easier movement of the cart 10. Each top end length 38 and 40 is also adapted with an aperture 42 and 44 along it side, proximate the handle 18, the aperture suitable for use in connecting to a lifting mechanism or crane if the cart 10 needs to be lifted to, or removed from a roof top surface.

The lower end 46 and 48 of each side wall 22 and 24 is adapted with a slight forward angle or bend such that the terminal end of the lower length 22 and 24 extends forwardly from the frame in the same plane as the wall 22 and 24. This forwardly extending end 50 and 52 is adapted for connection with and to secure the holding base 28 to the frame 14. The holding base 28 is connected to and between both ends 50 and 52. The ends 50 and 52 are each further adapted with an integral and inwardly extending base support 54 and 56. The base supports 54 and 56 are substantially flat, smooth rectangular sheets of steel or aluminum. The base supports 54 and 56 each have a length approximately equal to the length of end 50 or 52. The base supports 54 and 56 extend inwardly and away from the respective end 50 and 52 for a minimal distance, approximately less than the length of the holding base 28 itself. The base supports 54 and 56 are substantially parallel with, and positioned at least partially underneath the lower holding base 28. Thus, the base supports 54 and 56 and the lower holding base 28 are all substantially parallel with the upper holder 26 and the ground or other surface when the cart 10 is in an upright and stationary position.

The base supports 54 and 56 help support the cart 10 in the upright and stationary position when storing or loading and/or unloading at least one warning stand 60. The base supports 54 and 56 engage with a ground surface, or roof top surface, to hold the cart upright and immobile and to prevent unwanted rolling or rotation of the wheels 12.

The side walls 22 and 24 are further adapted proximate the lower ends 46 and 48 for rotatable connection with a first and second wheel. The pair of wheels 12 is rotatably secured to the cart 10 by an axle 12B extending through an opposing pair of aligned apertures in each side wall 22 and 24. The wheels are rotatably secured to the cart and positioned for connection at substantially the rearward most portion 47 and 49 of the lower end lengths 46 and 48. The wheels 12 are positioned in the back of the cart 10, to the rear of the lower holding base 28 and below the handles 18. The cart 10, when in an upright position and resting on the base supports 54 and 56 and wheels 12 supports the upper holding support 26 of the cart 10 in a position above and slightly to the rear of the lower holding base 28. Stands 60 placed in the cart 10 are generally retained in an upright and inclined position. The positioning of the upper holding support 26 and lower holding base 28 together form the storing mechanism 20 for retaining stands. The stands remain retained when the cart is stationary, and a further securing mechanism reinforces retaining the stands 60 when the cart is moved.

The storing mechanism 20 described above allows the stands 60 to be placed in the cart 10 for storage and transportation. When loading, the stands 60 easily remain secured in the cart 10 as the stands 60 each essentially “lean” on the upper holder 26 while the lower ends of the stands are retained by the lower holder 28. The cart is retained stationary and upright by the wheels 12 and engagement of base supports 54 and 56 with the ground or other surface.

As illustrated in further detail in FIG. 6, the lower holding base 28 has a substantially flat upwardly facing surface adapted with a plurality of upwardly extending prongs 76. The upwardly extending prongs are spaced apart along the length of the holding base 28. The prongs 76 may be cylindrical or rectangular in shape, or otherwise tubular and having any shape in cross section.

The upper holding support 26 comprises a rear wall, which is substantially flat and has a height of approximately 2-4 inches, or a height sufficient for the top section of a stand 60 to contact. Spaced along the rear wall of the upper holding support are a plurality of dividers 80. The dividers are sheets of aluminum or another suitable metal which extend outwardly from the rear wall to form a side wall. The open areas bounded by the rear wall and each divider 80 and the divider immediately adjacent thereto are spaces 78. The spaces 78 are of a sufficient width such that an upper end of a stand 60 can easily rest within the space, while the space is able to substantially limit or restrict side and rearward movement of the upper end of the stand 60.

Each prong 76 of the holding base 28 corresponds with a space 78 formed between two adjacent dividers 80 of the upper holder 26. Each of a plurality of stands 60 is generally a tubular length, having at least a hollow lower end. The hollow end of the stand 60 will connect with the prong 76. The upwardly extending prongs 76 are each adapted for insertion into the hollow lower portion of each stand 60 to secure the stand in the lower holder 28 of the cart 10. The prongs 76 of the lower holder 28 retain the stands upright and substantially restrict movement of the stand in all directions. As the prongs 76 have a height sufficient to engage with inner surface of the hollow lower portion of the stand 60, the prongs more effectively retain the stand 60 by preventing the stand from tipping forward or otherwise pivoting at the lower end in the lower holder. Movement is limited when the prong 76 is inserted in the stand. The upper end of the stand 60 then rests in corresponding space 78 on the upper holding support 26.

To secure the stands in the storing mechanism 20 of the cart 10 for transport or storage, the upper holding support 26 is further adapted with a cover 58. The cover 58 extends along the length of the upper holder 26 and is rotatably connected to the upper holder 26 via a hinge mechanism along a top edge rear wall of the upper holder 26. The cover 58 is rotatable about the hinge connection from an open position for loading the stands to a closed position for securing the stands in the cart. The cover 58, when closed restricts forward movement of the stands 60 and upward movement of the stands 60, thereby retaining the stands at their upper ends. The cover 58 is substantially an “L” shaped length of suitable metal, such that when in the closed position, the cover 58 has a top face 64 and a front face 66. The cover 58 is closed to secure each stand in a corresponding space 78 along the length of the upper holder 26. In a closed position, the open space 78 is defined by the rear wall of the upper holding support 26, adjacent dividers 80, top face 64, and front face 66. A bottom area is unobstructed such that the stands remain restrained in the space 78 by the lower end of each stand 60 resting on the holding base 28.

Once closed, the cover can further be secured in the closed position. The cover 58 is adapted on its front face 66 with a length extending beyond the length of the upper holder 26. The extended end lengths 68 and 70 of face 66 are adapted with apertures 69 and 71 that correspond with apertures in the upper holding support 26. The end, or terminal dividers 80 are further adapted with extending, outwardly facing plates 72 and 74 which are adapted with corresponding apertures 73 and 75. When cover 58 is closed, lengths 68 and 70 are aligned and substantially flush a respective extending plate 72 and 74. Said apertures are aligned and a pin or other securing fastener may be inserted.

When transporting the stands 60, or when storing the stands 60 and it is desired that the stands be further secured in the cart, the cover 58 can be moved to the closed position where it aids in retaining the stands 60 at their upper ends. As the lower ends of the stands are retained in the cart by insertion of a prong 76 into the hollow lower portion of the stand 60, the stands are retained in the cart 10 more securely. The stands are retained in the cart by mechanisms at both the upper and lower portions, which prevent unwanted movement in substantially all directions. The cover 58 closed and the locking mechanism described above as engaged, further securing the retained stands 60 such that the cart can be hoisted by a crane or lowered to ground, and/or the cart can moved over uneven surfaces, without significant movement of the stands 60.

A stand 60 is loaded into the cart by positioning the lower portion of the stand 60 over the prong 76 and lowering the stand over the prong 76 such that the stand rests downwardly upon the upward face of the lower holding base 28. The prong 76 allows the stand 60 to be held on or retained in the lower holding base 28 with minimal movement. The stands 60 are each retained orderly and in a space 78 defined by the upper holding support 26 and the lower holding base 28. As each prong 76 corresponds to a space 78 on the upper holding support 26, once the lower end of the stand is positioned over and connected with the prong 76, the upper end of the stand 60 is set within the corresponding space 78 on the upper holding support 26. The cover 58 can then be moved to the closed position to further secure each stand 60 in an upright position in the cart.

A reel or spool 16 is also rotatably secured to the backside of the upper holding unit 26 and is generally positioned in the space between the handles 18. The warning line itself can be wound around this spool 16 for transportation and storage along with the stands, and unwound from the spool 16 when marking a hazardous area.

The cart is also adapted with support bar 82. The support bar 82 extends across the frame 14, on the front side of the frame 14, and is secured to each side wall 22 and 24. The support bar 82 is a flat sheet of aluminum or another suitable material and provides stability for the frame and any stands held therein, especially when the cart is fully loaded with stands, and may be positioned proximate the mid-height of the cart 10 and positioned horizontally and substantially parallel to the upper holding support 26 and lower holding base 28.

Although the present invention has been described with reference to preferred embodiments, workers skilled in the art will recognize that changes may be made in form and detail without departing from the spirit and scope of the invention.

1. A wheeled cart for holding the components of a temporary visible warning assembly, the cart comprising:
a frame comprising:
a first and second side wall;
a holding support wherein the holding support comprises a plurality of spaces, the spaces being adjacent and positioned substantially along a length of the holding support and wherein each space is open to the extent it is bounded by a rear face, a first side face and a second opposing side face; and
a holding base, wherein the holding base comprises a plurality of upwardly extending prongs, the prongs being positioned substantially across a length of the holding base;
a first surface engaging support, the first support extending from the first side wall of the frame and directly below a length of the holding base proximate the first side wall;
a second surface engaging support, the second support extending from the second side wall of the frame and directly below a length of the holding base proximate the second side wall;
a pair of wheels; and
a rotatable cover, moveable from an open position to a closed position.

2. The cart of claim 1 and further comprising a spool secured to the holding support for storing a length of warning material;

3. The cart of claim 1 and further comprising a handle secured to the frame and configured to move the wheeled cart.

4. The cart of claim 1 wherein the cover is rotatably secured to the holding support and is movable between an open position for loading and a closed position.

5. The cart of claim 4 wherein the cover forms a top face and a front face of each of the plurality of spaces.

6. The cart of claim 1 wherein the plurality of spaces and the plurality of prongs are spaced apart and are aligned such that the each space corresponds with one prong.

7. The cart of claim 1 wherein the first and second side walls are vertical side walls and positioned parallel to one another wherein the upper end of the vertical side walls is positioned behind the lower end of the vertical side walls, which extend forwardly.

8. The cart of claim 7 wherein the holding support is horizontally secured between the first and second vertical side walls, and wherein the holding support is secured at a first height along the first and second vertical side walls.

9. The cart of claim 8 wherein the holding base is horizontally secured between the first and second vertical side walls, and wherein the holding base is secured at a second height along the first and second side walls, the second height being substantially lower than the first height.

10. The cart of claim 9 wherein the second height is proximate the surface and the first height is substantially there above, and wherein the holding base is secured to the side walls in a position forward to and below the holding support, the assembled frame remaining in an upright position.

11. The cart of claim 10 wherein components of the warning assembly comprise portable stands and wherein the prongs are configured for connection with lower portions of the stands and the spaces are configured to support the upper portion of the stands such that the stands can be stored in the cart.

12. A method of loading a wheeled cart for transporting components of a temporary visible warning assembly, the method comprising:
placing a plurality of stands in a wheeled cart by placing a first stand having a hollow lower end over a first upwardly extending prong of a holding base and inserting the first prong into the hollow lower end of the stand by setting the stand down on the holding base and further placing an upper end of the first stand in a corresponding gap on an upper retaining support, the support positioned parallel to and above the holding base wherein the support is positioned to the rear of the base such that the support and base holding the stand allow the first stand to rest at a rearward incline;
placing the remaining stands in the wheeled cart; and
closing a cover rotatably attached to the upper retaining support, the cover substantially co-extending with the length of the upper retaining support, by moving the cover from a loading position to the closed position over the upper ends of the plurality of stands.

13. The method of claim 12 and further comprising the step of loading a length of warning line on to a spool secured to the wheeled cart.

14. The method of claim 12 and further comprising the steps of:
disengaging stationary surface supports by grabbing rearwardly attached and rearwardly facing handles and tilting the cart slightly backward; and
pushing the cart to a selected surface for unloading of the components.
